(19) United States
(12) Patent Application Publication
(10) Pub. No.: US 2024/0362005 A1
(43) Pub. Date: Oct. 31, 2024

(54) COMPONENT INTEGRATION METHOD, APPARATUS, DEVICE, AND STORAGE MEDIUM

(71) Applicant: Beijing Zitiao Network Technology Co., Ltd., Beijing (CN)

(72) Inventors: Wei XU, Beijing (CN); Hongwei FAN, Beijing (CN); Xiangyu ZHAO, Beijing (CN); Zhouyou ZHOU, Beijing (CN); Haowei GU, Beijing (CN)

(21) Appl. No.: 18/647,243

(22) Filed: Apr. 26, 2024

(30) Foreign Application Priority Data
Apr. 26, 2023 (CN) 202310464874.1

(51) Int. Cl. G06F 8/61; G06F 8/71; G06F 11/36

(52) U.S. Cl. CPC G06F 8/61; G06F 8/71; G06F 11/368

(57) ABSTRACT

Embodiments of the present disclosure disclose component an integration method, an apparatus, a device, and a storage medium, and relate to the computer technology field. The method is applied at a service-side of a customized development system and comprises: obtaining a customized component corresponding to a customized function submitted by the client, wherein the customized component is developed based on a development protocol provided by the service-side; performing a pre-integration test for the customized component; in case that test is passed, sending to the client a debugging installation package including the customized component; after receiving a component release request corresponding to the customized component sent by the client, generating a customized installation package including the customized component and the host application. By adopting the above technical solution, the customized installation package can precisely meet the customization needs of the enterprise customers, save development costs, and enhance development efficiency.

### CROSS-REFERENCE TO RELATED APPLICATION(S)

This application claims priority to Chinese Application No. 202310464874.1 filed Apr. 26, 2023, the disclosure of which is incorporated herein by reference in its entity.

### FIELD

Embodiments of the present disclosure relates to the field of computer technology, and more specifically, to component integration method, apparatus, device, and storage medium.

### BACKGROUND

In a scenario where application software is delivered to enterprises, the customization needs of the enterprise customers become more and more diverse. For example, operational flows or application interfaces are modified to meet the requirements of the enterprises for special functions.

Currently, a customized function is usually implemented by: pre-embedding a runtime or compile-time switch control for a customized function and enabling the switch or completing related configurations for an enterprise to which the customized function is needed to bedelivered. As such, the enterprise-customized version is provided with the customized function.

### SUMMARY

Embodiments of the present disclosure provide component integration method, apparatus, storage medium, and device to optimize the existing application development schemes for customized functions of the enterprises.

In a first aspect, embodiments of the present disclosure provide a component integration method applied at a service-side of a customized development system, the customized development system further includes a first client, wherein the method comprises:
obtaining a first customized component corresponding to a first customized function submitted by the first client, wherein the first customized component is developed based on a development protocol provided by the service-side, the first customized function is used for meeting customization needs of a target user for a host application;
performing a pre-integration test for the first customized component;
in case that a test result of the pre-integration test is PASS, sending to the first client a first debugging installation package including the first customized component;
after receiving a component release request corresponding to the first customized component sent by the first client, generating a customized installation package including the first customized component and the host application.

In a second aspect, embodiments of the present disclosure also provide a component integration apparatus configured at a service-side in a customized development system, the customized development system further includes a first client, wherein the apparatus comprises:
a customized component obtaining module for obtaining a first customized component corresponding to a first customized function submitted by the first client, wherein the first customized component is developed based on a development protocol provided by the service-side, the first customized function is used for meeting customization needs of a target user for a host application;
a pre-integration testing module for performing a pre-integration test for the first customized component;
a debugging installation package sending module for sending to the first client a first debugging installation package including the first customized component in case that a test result of the pre-integration test is PASS;
a customized installation package generating module for generating a customized installation package including the first customized component and the host application after receiving a component release request corresponding to the first customized component sent by the first client.

In a third aspect, embodiments of the present disclosure also provide an electronic device, comprising:
one or more processors;
a storage for storing one or more programs;
when the one or more programs are executed by the one or more processors, the one or more processors are caused to implement the component integration method provided by the embodiments of the present disclosure.

In a fourth aspect, embodiments of the present disclosure also provide a storage medium containing computer executable instructions, wherein the computer executable instructions, when executed by a computer processor, perform the component integration method provided by the embodiments of the present disclosure.

The component integration scheme provided by the embodiments of the present application is applied at a service-side of a customized development system, and the customized development system further includes a first client. The scheme comprises: obtaining a first customized component corresponding to a first customized function submitted by the first client, wherein the first customized component is developed based on a development protocol provided by the service-side, the first customized function is used for meeting customization needs of a target user for a host application; performing a pre-integration test for the first customized component; in case that a test result of the pre-integration test is PASS, sending to the first client a first debugging installation package including the first customized component; after receiving a component release request corresponding to the first customized component sent by the first client, generating a customized installation package including the first customized component and the host application. By adopting the above technical scheme, the application developer may open the customization development capability to the enterprise customers with customization needs, such that the enterprise customer side can fulfill their customized needs. Accordingly, a process for developing the customized function of the enterprise customer side is decoupled from a process for developing the native application to reduce or even eliminate development work from the application developer targeted at the customization needs of the enterprise customers, thereby saving development costs, enhancing development efficiency and making the future maintenance less difficult. Subsequent to obtaining the customized component submitted by the client, the service-side in the customized development system first conducts the pre-integration test and then returns a debugging installation package to the client after the component passes the test. After receiving the component release request from the client, a customized installation package including the customized component is generated, to ensure normal integration of the customized function. As a result, the generated installation package can precisely meet the customization needs of the enterprise customer.

### BRIEF DESCRIPTION OF THE DRAWINGS

Through the following detailed implementations with reference to the accompanying drawings, the above and other features, advantages and aspects of various embodiments of the present disclosure will become more apparent. Throughout the drawings, same or similar reference signs indicate same or similar elements. It is to be understood that the drawings are exemplary, in which original components and elements are not necessarily drawn to scale.

FIG. 1 illustrates a schematic diagram of an application scenario of a component integration method provided by embodiments of the present application;

FIG. 2 illustrates a schematic diagram of an application scenario of a component integration method provided by embodiments of the present application;

FIG. 3 illustrates a schematic flowchart of a further component integration method provided by the embodiments of the present disclosure;

FIG. 4 illustrates a schematic work flow chart of a component integration solution provided by the embodiments of the present disclosure;

FIG. 5 illustrates a schematic diagram of the pre-integration test procedure provided by the embodiments of the present disclosure;

FIG. 6 illustrates a schematic diagram of the injection at the compilation phase provided by the embodiments of the present application;

FIG. 7 illustrates a schematic diagram of the injection at the runtime phase provided by the embodiments of the present application;

FIG. 8 illustrates a schematic work flow chart of a further component integration solution provided by the embodiments of the present disclosure;

FIG. 9 illustrates a structural diagram of a component integration apparatus provided by the embodiments of the present disclosure;

FIG. 10 illustrates a structural diagram of an electronic device provided by the embodiments of the present disclosure.

### DETAILED DESCRIPTION OF EMBODIMENTS

The embodiments of the present disclosure will be described in more details with reference to the drawings. Although the drawings illustrate some embodiments of the present disclosure, it should be appreciated that the present disclosure can be implemented in various manners and should not be limited to the embodiments explained herein. On the contrary, the embodiments are provided to make the present disclosure more thorough and complete. It should be appreciated that the drawings and the embodiments of the present disclosure are provided only for exemplary purpose, rather than restricting the protection scope of the present disclosure.

It is to be understood that respective steps disclosed in the method implementations of the present disclosure may be executed in different orders and/or in parallel. Besides, the method implementations may include additional steps and/or omit the demonstrated steps. The scope of the present disclosure is not restricted in this regard.

As used herein, the term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” The term “some embodiments” is to be read as “at least some embodiments”. Related definitions of other terms may be provided in the following description.

It is to be noted that “first” and “second” are disclosed in the present disclosure merely for distinguishing different apparatuses, modules or units, rather than restricting the sequence of the functions executed by the apparatuses, modules or units or the interdependency among the apparatuses, modules or units.

It is to be noted that the terms “one” and “more” disclosed in the present disclosure are exemplary rather than restrictive. Those skilled in the art should understand that the above terms are to be read as “one or more” unless indicated otherwise in the context.

Names of the messages or information exchanged between a plurality of apparatuses in the implementations of the present disclosure are provided only for explanatory purpose, rather than restricting the scope of the messages or information.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

It is to be understood that data (including but not limited to the data per se, acquisition or use of the data) involved in the technical solution should comply with corresponding laws and regulations.

To understand the technical solution in the embodiments of the present disclosure, relevant technologies are introduced below. In a scenario where application software is delivered to enterprises, a customized function is usually implemented by: pre-embedding a runtime or compile-time switch control for customization and enabling the switch or completing related configurations for an enterprise to which the customized function is delivered. As such, the enterprise-customized version is provided with the customized function. In other words, the customized function for enterprise customers should be developed by application program developers. However, the customization needs of the enterprise customers tend to be diverse, making it difficult to accurately customize and develop a function. Generally, generalized abstract transformations are only carried out on the customization needs to acquire the customized function and configure the above switch. In case of changes in the needs of the enterprise customers, corresponding modifications are also required, which is difficult to maintain. Besides, some non-universal functions could not be loaded on the existing application software products, so the needs of the enterprise customers could not be accurately met.

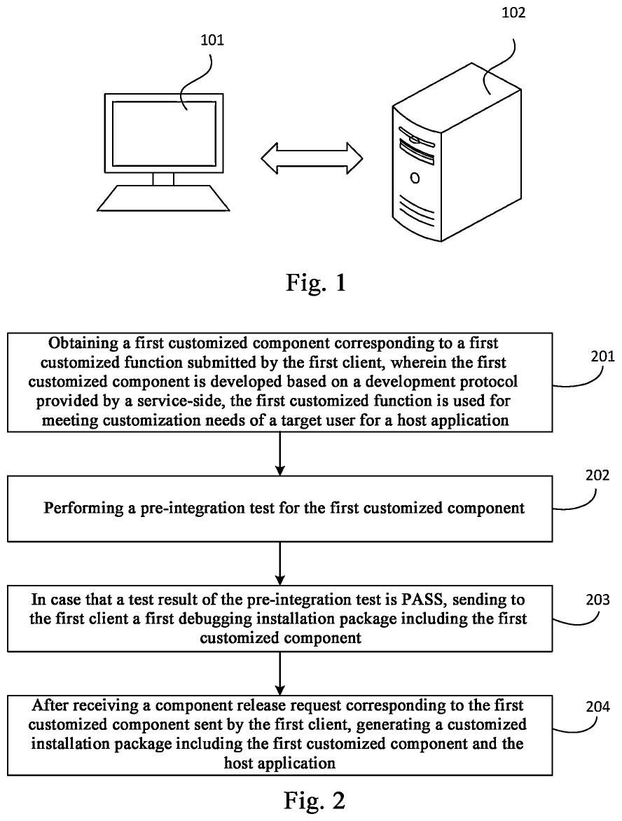

In the embodiments of the present disclosure, for function customization scenarios, an application development framework may be transformed into an open framework and a customized development system which allows containerization of customized functions is provided. By externally providing a development protocol corresponding to the container, abstraction may be provided to enterprise customers having customization needs. As such, developers from enterprise customers can complete the development of custom functions in the native open scenario of the host application and obtain customized installation packages, thereby fulfilling delivery of application software directed to specific needs. FIG. 1 illustrates a schematic diagram of an application scenario of a component integration method provided by embodiments of the present application. The customized development system includes a client 101 and a service-side 102, and the customized installation packages of the enterprise customers are generated through interactions between the service-side 102 and the client 101.

FIG. 2 illustrates a flowchart of a component integration method provided by embodiments of the present disclosure. Embodiments of the present disclosure are adapted to generate customized installation packages that meet the customization needs of the enterprise users in the scenarios of delivering application software to enterprises. The method can be executed by a component integration apparatus, which apparatus may be implemented by software and/or hardware, or optionally by an electronic device that is configured as the service-side in the customized development system, specifically being server or cloud platform etc.

As shown in FIG. 2, the method comprises:

Step 201: obtaining a first customized component corresponding to a first customized function submitted by the first client, wherein the first customized component is developed based on a development protocol provided by the service-side, the first customized function is used for meeting customization needs of a target user for a host application.

As an example, the client (hereinafter referred to as “client”) in the customized development system may be appreciated as a developer tool provided to enterprise customers or a third party (both jointly referred to as “customization developer” below) entrusted by the enterprise customers. A first client may be any client capable of interacting with the service-side in the customized development system. The host application may be interpreted as a native application developed by application program developers, includes standard capability of an application program, is free of client-customized logics and corresponds to original installation packages and original software project. Specific types of the application programs are not restricted in the embodiments of the present application and the application programs for example may be online office software or enterprise management software etc.

As an example, the customized function may be understood as a function that is opened by the application developer to allow enterprise customers to customize a function, including for example related functions involved in the application operation flow or application interface. A first customized function may be interpreted as a customized function which is required to add into the host application by a target user. For example, when the application program is switched to foreground from background, it is required to display an application unlock interface specific to the enterprise customers. For another example, security capability, including encryption and decryption, is provided in a webpage or an applet container of the application program. The target user may be appreciated as the target client, specifically being an enterprise customer currently having customization needs for the host application or a user utilizing the first client, such as staff from the customization developer in charge of code development and the like.

As an example, the customization developer may obtain, via the client, a demo project corresponding to the host application. The demo project may contain demos related to application development and development baseline compatible with the host application. The development baseline includes development protocols adapted to the host application. The development protocols may be understood as software specification agreement of the function with customization power, including code protocols (such as code protocols that need to be followed for extensions of the application program login page or life cycle) that need to be followed to implement the customized function. Specifically, it may be an abstract code flow of the customized function and the detailed implementation of the abstract code flow may be determined by the customization developer through compiling the codes. The development protocols also may include the existing capability of the host application that can be called by the customization developer, the existing capability for example being Application Programming Interface (API) in the host application. After obtaining the development protocol corresponding to the function to be customized through the client, the customization developer may write the corresponding development codes and compile the written development codes at the client, to obtain a corresponding customized component.

Optionally, the method, prior to obtaining a first customized component corresponding to a first customized function submitted by the first client, further comprises: providing to the first client a demo project corresponding to the host application, wherein the demo project includes the development protocol. Accordingly, the customization developer may obtain the development protocol for development of the customized component directly through interactions between the first client and the service-side.

Exemplarily, the customization developer writes first development codes via the first client on the basis of the development protocol corresponding to the first customized function provided by the service-side. The first client compiles the first development codes to obtain the first customized component, which is submitted to the service-side.

Optionally, compiling the first development codes by the first client may include: the first client reads dependency statements of components involved in the first development codes, establishes a dependency relationship graph (e.g., dependency relationship in tree structure) based on the dependency statements and compiles the first development codes in accordance with the dependency relationship graph. The first customized component obtained from the compilation may specifically be a compiled binary product, wherein the dependency graph may contain dependencies among respective components.

Step 202: performing a pre-integration test for the first customized component.

As an example, a pre-integration test may be understood as a preliminary test to determine whether the first customized component can be integrated with the host application. Optionally, the pre-integration test may include testing contents of the first customized component, e.g., security or compatibility test etc. The pre-integration test also may include a compilation pass test. For example, it is tested whether it is a success to jointly compile and build the first customized component and the host application.

Step 203: in case that a test result of the pre-integration test is PASS, sending to the first client a first debugging installation package including the first customized component.

As an example, subsequent to the pre-integration test, if the test result is PASS, it is believed that the first customized component meets the basic condition for integration into the host application. To ensure that the first customized component can fulfill the first customized function after being integrated to the host application, the service-side sends to the first client a first debugging installation package, wherein the first debugging installation package is provided to the first client for debugging the first customized component. Optionally, the first debugging installation package is obtained through performing joint compiling and building on the first customized component and the host application, to facilitate the customization developer to carry out a more comprehensive function verification on the first customized component integrated into the host application and debug the logic of the first customized component. If the first customized component and the host application have been jointly compiled and built during the pre-integration test process and the compilation is passed, an installation package resulted from the joint compilation and building may serve as the first debugging installation package. After receiving the first debugging installation package via the first client, the customization developer may perform function verification and logic debugging on the first customized function. Such verification and debugging process may be completed through the above demo project. Optionally, the first client sends to the service-side a corresponding component release request after a successful debugging of the first customized component on the basis of the first debugging installation package. In other words, subsequent to a successful debugging, the first client may initiate release of the first customized component to the service-side, such that the first customized component can be integrated into the installation package.

Step 204: after receiving a component release request corresponding to the first customized component sent by the first client, generating a customized installation package including the first customized component and the host application.

Exemplarily, after receiving the component release request corresponding to the first customized component sent by the first client, the service-side may determine that the first debugging installation package corresponding to the first customized component has been successfully debugged and a customized installation package including the first customized component and the host application can be generated, thereby delivering an application that meets the customization needs of the target user.

The component integration method provided by the embodiments of the present application is applied at a service-side of a customized development system, and the customized development system further includes a first client. The scheme comprises: obtaining a first customized component corresponding to a first customized function submitted by the first client, wherein the first customized component is developed based on a development protocol provided by the service-side, the first customized function is used for meeting customization needs of a target user for a host application; performing a pre-integration test for the first customized component; in case that a test result of the pre-integration test is PASS, sending to the first client a first debugging installation package including the first customized component; after receiving a component release request corresponding to the first customized component sent by the first client, generating a customized installation package including the first customized component and the host application. By adopting the above technical solution, the application developer may open the customization development capability to the enterprise customers with customization needs, such that the enterprise customer side can fulfill their customized needs. Accordingly, a process for developing the customized function of the enterprise customer side is decoupled from a process for developing the native application to reduce or even eliminate development work from the application developer targeted at the customization needs of the enterprise customers, thereby saving development costs, enhancing development efficiency and making the future maintenance less difficult. Subsequent to obtaining the customized component submitted by the client, the service-side in the customized development system first conducts the pre-integration test and then returns a debugging installation package to the client after the component passes the test. After receiving the component release request from the client, a customized installation package including the customized component is generated, to ensure normal integration of the customized function. As a result, the generated installation package can precisely meet the customization needs of the enterprise customer.

In some embodiments, the performing a pre-integration test for the first customized component includes: performing a content test on the first customized component; after the content test is passed, performing joint compiling and building on the first customized component and the host application; if compilation is passed, obtaining an initial debugging installation package; performing an owned service logic test of the host application for the initial debugging installation package, wherein the first debugging installation package includes an initial debugging installation package after the owned service logic test is passed. As such, the first customized component may be subject to a comprehensive pre-integration test, including contents and compilation pass test of the customized component, to discover the issues existing in the first customized component in time and avoid spending massive amount of time on adjustments due to issues discovered in the subsequent integration process.

Optionally, the performing a content test on the first customized component includes: determining whether there is a call symbol for calling a preset interface in the first customized component, wherein a preset interface specifically may be API interface. For example, the interface may be a preset illegal interface, i.e., an interface that is not allowed to be called by the customization developer as predetermined by the application developer, such as interface related to user data privacy. Accordingly, it is tested whether the first customized component calls the illegal interface. As an example, the first customized component may be scanned for a call symbol. If there is a call symbol for calling the preset interface, the preset interface is called and the content test fails. Optionally, a prompt message of failure of the content test may be further fed to the first client, the prompt message for example indicating identity or name of the preset interface called by the first customized component.

Optionally, the performing a content test on the first customized component includes: determining whether a dependency relationship graph corresponding to the first customized component conflicts with dependency relationship corresponding to the host application. This may avoid causing problems after the installation of the customized installation package due to dependency relationship conflicts. For example, in case that the first customized component and the host application both depend on open source components, such as navigation component, but the dependent open source components differ in versions, e.g., version 1.0 and version 2.0 respectively, it may be considered that the dependency relationship graph corresponding to the first customized component is in conflict with the dependency relationship corresponding to the host application. If conflict occurs, it is believed that the content test fails. Optionally, the prompt message of failure of the content test may be further fed to the first client, the prompt message for example indicating identity or name of the open source components on which the first customized component depends and version of the open source component on which the host application depends etc.

Optionally, a dependency relationship graph corresponding to the first customized component is submitted by the first client to the service-side. For example, when submitted to the service-side, the first customized component may be submitted in association with the dependency relationship graph. Therefore, the service-side may perform the above dependency relationship conflict test directly in accordance with the dependency relationship graph in association with the first customized component submitted by the first client.

Optionally, the performing a content test on the first customized component includes: determining whether there are conflicting method symbols and/or variables between the first customized component and the host application. Accordingly, this may avoid causing problems after the installation of the customized installation package due to method symbol and/or variable conflict. For example, when the first customized component and the host application have the method a or the variable b of the same name, it is believed that there are conflicting method symbols and/or variables. In such case, it is considered that the content test fails. Optionally, the prompt message of failure of the content test may be further fed to the first client, the prompt message for example indicating the presence of conflicting method symbols and/or variables in the first customized component.

Optionally, the content test performed on the first customized component may include one or more of the above items. When the content test contains multiple items, it becomes more comprehensive. In case of failure of any of the above items, it is deemed that the content test fails.

As an example, as to the joint compilation and building of the first customized component and the host application, a dependency record of the first customized component for example may be added into preconfigured files of the software project corresponding to the host application, wherein the preconfigured files contain components on which compilation of the software project depends. By adding the dependency record of the first customized component, the joint compilation and building can successfully depend on the first customized component. The first customized component and the host application are jointly compiled and built using a compiler, to inject dependency on the first customized component. If the compiler can successfully output a compilation result, it is believed that the compilation passes.

Exemplarily, if the compilation passes, the compiled installation package is labeled as an initial debugging installation package. To avoid the injection of the customized component from affecting the owned service logic of the host application, an owned service logic test of the host application can be performed for the initial debugging installation package. The owned service logic test, for example, may include User Interface (UI) automation test.

In some embodiments, the generating a customized installation package including the first customized component and the host application after receiving a component release request corresponding to the first customized component sent by the first client includes: hosting the first customized component after receiving a component release request corresponding to the first customized component sent by the first client; in response to generating instructions for a customized installation package of the target user, performing an integration test on a hosted customized component of the target user; in case that a test result of the integration test is PASS, generating a customized installation package including the hosted customized component and the host application. Accordingly, as to generation of the customized installation package, all hosted customized components under the target user may be integrated for integration test from the perspective of the target user, to enhance the efficiency for function customization and shorten the customization delivery cycle.

As an example, after the pre-integration test is passed, the first customized component and the feature identify of the target user may be stored in association. After the receipt of the component release request, the first customized component and the feature identify of the target user stored are hosted. Optionally, if the first customized component is submitted in association with the dependency relationship graph, the dependency relationship graph may be stored associatively.

Optionally, performing the integration test on the hosted customized component of the target user may include: searching (e.g., searching in a component integration information sheet that may store relations between feature identifies of respective clients and hosted customized components) the corresponding hosted customized component on the basis of the feature identify of the target user. Exemplarily, the integrated test contains fewer items than the pre-integration test. For instance, the compilation pass test may be performed and the content test is omitted.

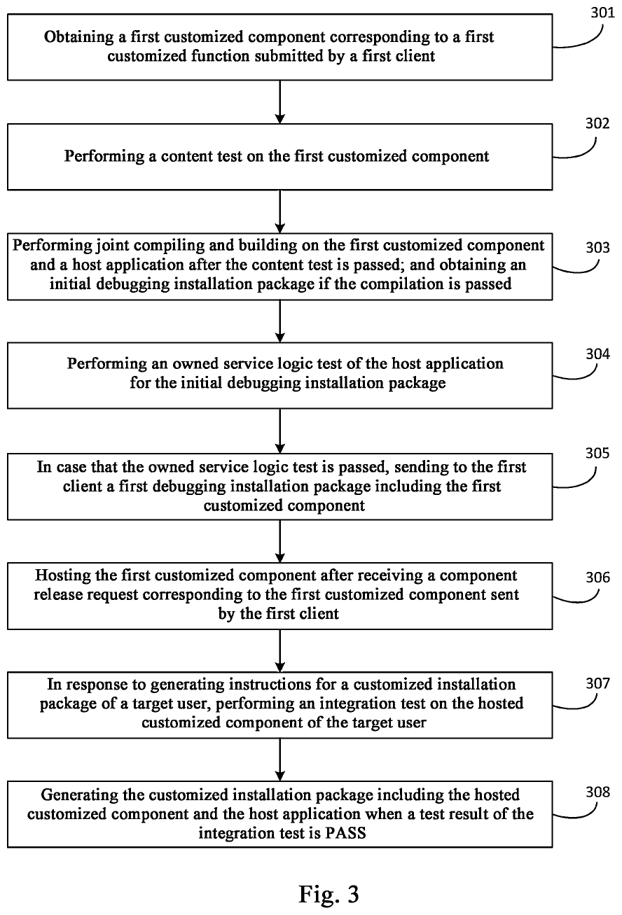

FIG. 3 illustrates a schematic flowchart of a further component integration method provided by the embodiments of the present disclosure. These embodiments of the present disclosure are optimized on the basis of the respective optional solutions in the above embodiments. Specifically, the method includes following steps:

At step 301, the first customized component corresponding to the first customized function submitted by the first client is obtained.

At step 302, the content test is performed on the first customized component.

As an example, the content test includes: scanning the first customized component for a call symbol and determining whether there is a call symbol for calling a preset interface; analyzing a dependency relationship graph corresponding to the first customized component and determining whether it conflicts with the dependency relationship corresponding to the host application; and determining whether the first customized component and the host application have conflicting method symbols and/or variables. If all items pass, it is believed that the test result of the content test is PASS.

At step 303, the first customized component and the host application are jointly compiled and built after the content test is passed; and the initial debugging installation package is obtained if the compilation is passed.

Optionally, if the content test or the compilation fails, a prompt message is sent to the first client to indicate the first client to modify the first customized component and resubmit the modified component.

At step 304, an owned service logic test of the host application is performed for the initial debugging installation package.

At step 305, in case that the owned service logic test is passed, the first debugging installation package including the first customized component is sent to the first client.

As an example, if the owned service logic test is passed, it is deemed that the test result of the pre-integration test is PASS. Optionally, if the owned service logic test fails, a prompt message is sent to the first client to indicate the first client to modify the first customized component and resubmit the modified component.

At step 306, the first customized component is hosted after receiving the component release request corresponding to the first customized component sent by the first client.

At step 307, in response to generating instructions for the customized installation package of the target user, the hosted customized component of the target user is subject to the integration test.

Optionally, the customized development system further includes a second client; the hosted customized component includes a second customized component, the second customized component includes a customized component corresponding to a second customized function desired by the target user as submitted by the second client to the service-side. As such, for the same enterprise customer, the customized components submitted by different customization developers may be combined and integrated and a combined delivery is present to the enterprise customers. The second customized function may be the same as or different from the first customized function. If they are the same, it is considered that the first client and the second client may cooperate to complete the development of the same customized function, e.g., the customized function is fulfilled by cooperation from the first customized component and the second customized component, wherein the pre-integration test for the second customized component and corresponding interactions related to the second debugging installation package are similar to those for the first customized component and will not be repeated here.

Optionally, the performing an integration test on a hosted customized component of the target user includes: performing joint compiling and building on a hosted customized component of the target user and the host application; if compilation is passed, obtaining an initial customized installation package; performing an owned service logic test of the host application for the initial installation package, wherein the customized installation package includes an initial customized installation package after the owned service logic test is passed. Therefore, through the compilation pass test and the owned service logic test, it is ensured that the resulting customized installation package can successfully integrate the hosted customized components of the target user and the existing functions referenced by the host operates normally.

At step 308, the customized installation package including the hosted customized component and the host application is generated when the test result of the integration test is PASS.

As an example, the customized installation package includes the initial customized installation package after the owned service logic test is passed. That is, in case that the test result of the integration test is PASS, the initial customized installation package may be transferred from intranet to public networks and provided to the target users for download and use. A message indicating success of component release is returned to the client.

In the component integration method provided by the embodiments of the present disclosure, the service-side performs the content test, the compilation pass test and the owned service logic test on the customized components submitted by the client. After the comprehensive pre-integration test is passed, the debugging installation package is returned to the client. Subsequent to a successful debugging by the client, extension components are hosted. When a request for generating a customized installation package is received, the hosted customized components of the target user are subject to the integration test; in case that the test result of the integration test is PASS, the customized installation package including the hosted customized components and the host application is generated. While the existing functions of the host application remain normal, the customized functions oriented to the enterprise customers may be efficiently integrated, thereby effectively reducing the customization development costs and the maintenance overheads, enhancing the function customization efficiency and shortening the customization delivery cycle.

Optionally, after the customized installation package is generated, the user corresponding to the target user may install the customized installation package to obtain a customized application program. The logic of the customized components is correspondingly injected in a dependent manner during the integrated compilation and building. In the runtime phase of the customized application program, the customized logic injected during compilation can be obtained after startup, and the customized logic is added to the service container to be executed for the implementation of customized functions. When it is required to use the customized function, the customized logic of the corresponding customized component is executed to implement the customized function.

In some embodiments, after the first customized component is obtained or the component release request corresponding to the first customized component is received, it may be determined whether the target user corresponding to the first customized component exists in the preset customer information sheet. The preset customer information sheet, for example, may include authorized enterprise customers. If an enterprise customer is authorized, it means that the client has been qualified for submitting the customized component to the service-side, so as to authenticate the identity of the target user and ensure application security. After the identity authentication is passed, subsequent processing of the first customized component continues.

In some embodiments, after the first customized component is obtained or the component release request corresponding to the first customized component is received, the version of the development protocol corresponding to the first customized component may also be tested to determine whether the version is compatible with the version of the host application that is currently to be integrated as needed. For example, the service-side may obtain baseline information from a baseline information sheet and the baseline information contains an open container version adapted to the current version of the host application. The component release request may include an open container version corresponding to the first customized component, to further determine whether the host application version is compatible with the open container version. If not, failure information may be returned.

In some embodiments, after the first customized component is obtained or the component release request corresponding to the first customized component is received, the method may further include: determining whether the hosted target customized component exists in the first customized function; if existing, it is determined whether the version of the first customized component is lower than the version of the target customized component; if yes, the failure information is returned to avoid version degradation.

In some embodiments, the method further comprises: upon detecting that a version of the host application is upgraded to a target application version, sending a re-release notification to the first client; receiving a component re-release request of the first customized component sent by the first client, wherein the component re-release request includes a target development protocol version corresponding to the first customized component; upon determining that the target application version is compatible with the target development protocol version, generating a customized installation package including the first customized component and a host application of the target application version. Thus, if the version of the development protocol for writing the first customized component is compatible with the upgraded version of the host application, it is unnecessary to redo writing, compiling and pre-integration test and other related steps of the first customized component, thereby increasing the iteration efficiency of the customized installation package.

Optionally, upon determining that the target application version is incompatible with the target development protocol version, a re-integration notification is sent to the first client, wherein the re-integration notification is used for prompting re-developing of the first customized component adopting a new development protocol compatible with the target application version, so as to ensure normal operation of the first customized function.

For a better understanding of the technical solution of the embodiments of the present disclosure, further explanation is provided below with reference to the related schematic diagrams of work flow.

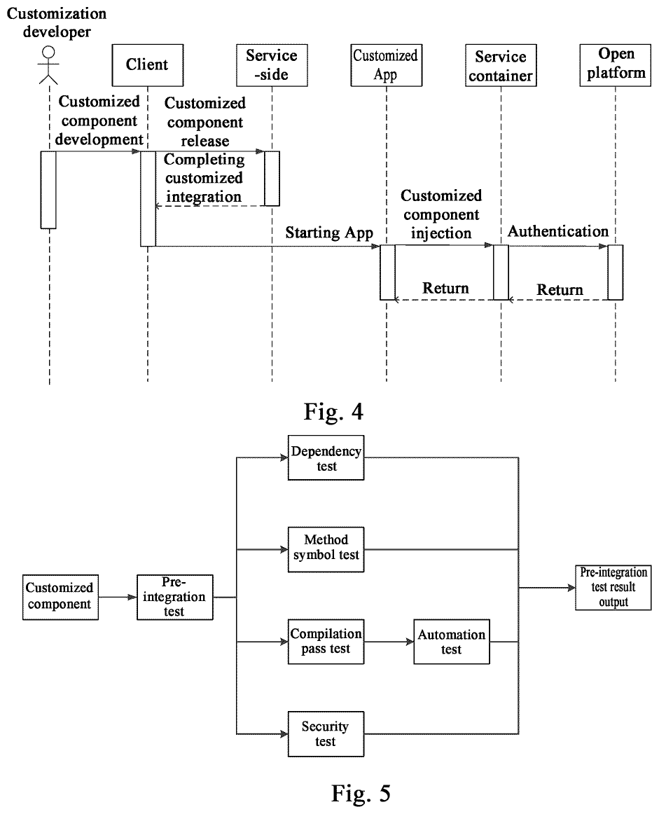

FIG. 4 illustrates a schematic work flow chart of a component integration solution provided by the embodiments of the present disclosure. FIG. 4 demonstrates development, integration and usage of the customized application. The customization developer develops the customized component via the client in the customized development system and then initiates release of the customized component to the service-side through the client. The service-side completes the customized integration of the customized component, obtains the customized installation package and then returns the customized installation package to the client. Upon completion of the customized package, a customized application program (customized App) may be started. At runtime phase of the customized App, the customized logic injected during compilation is obtained. For the implementation of the customized logic, the customized logic is injected into a service container to be executed. When a customized component needs to call a self-capable API in the host application, a corresponding capability authentication is performed, such as permission authentication or visibility capability authentication etc. If the authentication is passed, the customized component is permitted to call the corresponding API.

FIG. 5 illustrates a schematic diagram of the pre-integration test procedure provided by the embodiments of the present disclosure. As shown in FIG. 5, after obtaining the customized component, the service-side performs the pre-integration test for the customized component. Specifically, the pre-integration test may include dependency test, i.e., it is determined whether the dependency relationship graph corresponding to the customized component conflicts with the dependency relationship corresponding to the host application. The pre-integration test also includes method symbol test, which determines whether there are conflicting method symbols and/or variables between the customized component and the host application. The pre-integration test further includes a security test to determine whether the customized component includes a call symbol for calling the preset interface. The pre-integration test further includes a compilation pass test. After the compilation pass test, the automation test begins.

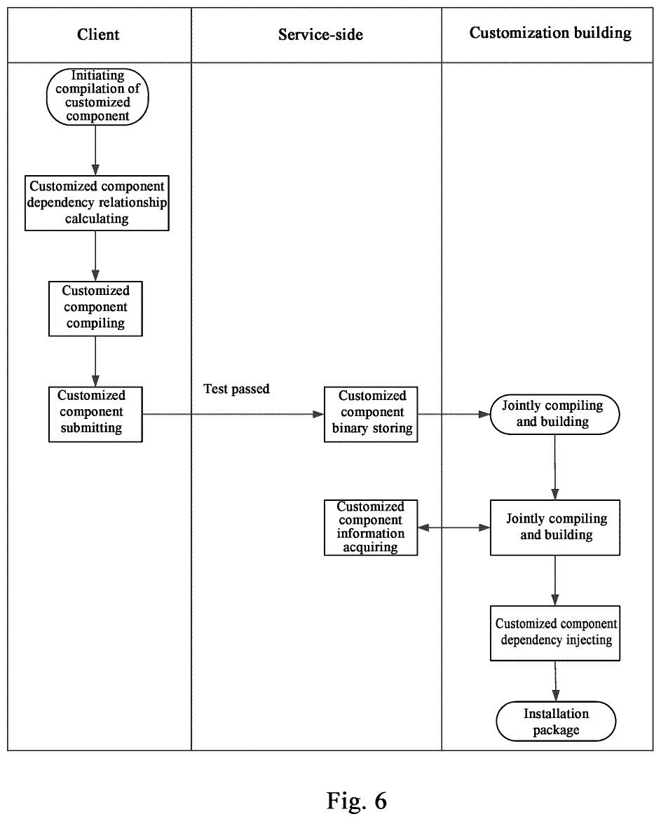

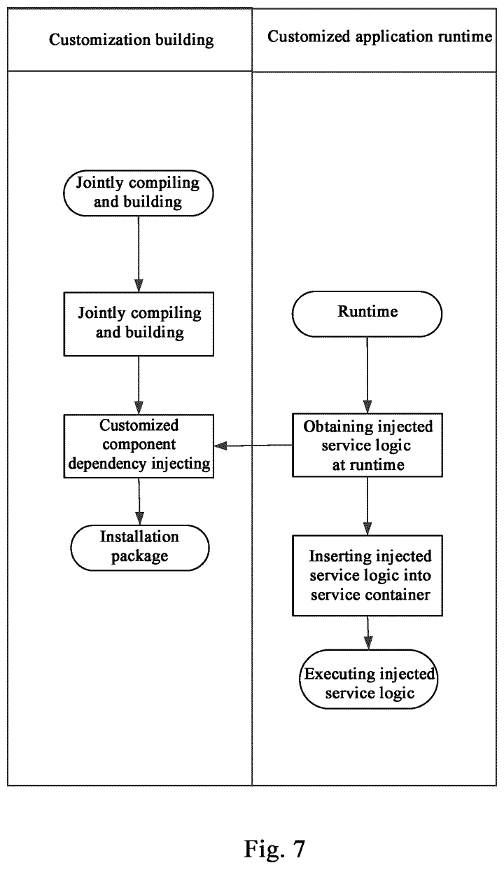

The component integration scheme proposed by the embodiments of the present disclosure involves two injections of the component at compilation phase and runtime phase respectively. FIG. 6 illustrates a schematic diagram of the injection at the compilation phase provided by the embodiments of the present application. As shown in FIG. 6, the customization developer initiates the integrated compilation of the customized components, and the client locally calculates the dependencies of the customized components to obtain a dependency relationship graph. The customized components are compiled based on the dependency relationship graph and submitted to the service-side for compilation in pre-integration test or integration test. After passing relevant tests, the compiled binary product and dependency relationship graph are stored in the database in association. When joint compilation is required, the compiler obtains the binary product and dependency relationship graph for joint integration and compilation, and performs binary injection of the customized components, to complete the compilation and obtain the corresponding installation package. FIG. 7 illustrates a schematic diagram of the injection at the runtime phase provided by the embodiments of the present application. As shown in FIG. 7, the service logic (customized logic) injected at the compilation phase is obtained during the operation of the customized application, and the externally injected service logic obtained is inserted into the service container. When the customized function is required for use, the injected service logic will be executed.

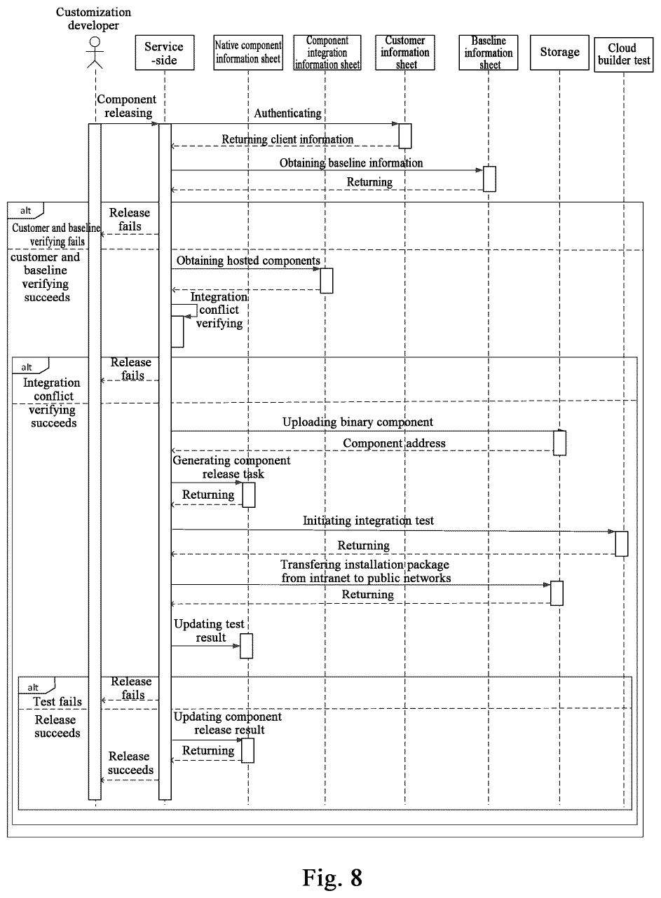

FIG. 8 illustrates a schematic work flow chart of a further component integration solution provided by the embodiments of the present disclosure and demonstrates the release procedure of the customized component. As shown, after the customization developer sends a component release request to the service-side through the client, the service-side obtains the client information from the customer information sheet and returns it to the service-side. The service-side authenticates the client identity and obtains the baseline information from the baseline information sheet to verify the baseline version of the customized component. If either one fails, failure of component release is returned to the client. If both verifications are successful, the service-side obtains from the component integration information sheet the currently released integrated component information of the client, to determine whether there is a conflict between the currently released component information and the integrated component information, e.g., whether there is a version degradation etc. If there is an integration conflict, failure of the component release is returned to the client. If there are no integration conflicts, i.e., successful verification, the binary data of the current customized components are uploaded to a storage service, a component release task is generated, information concerned with the host application is obtained from the native component information sheet and an integration test is initiated for a cloud builder test service. Besides, the jointly compiled and built installation package is transferred from intranet to public networks for storage and the native component information sheet is updated with the builder test result. In case of failure of the integration test, failure of the component release is returned to the client. If the integration test is passed, the native component information sheet is updated with the component release data and success of the component release is returned to the client.

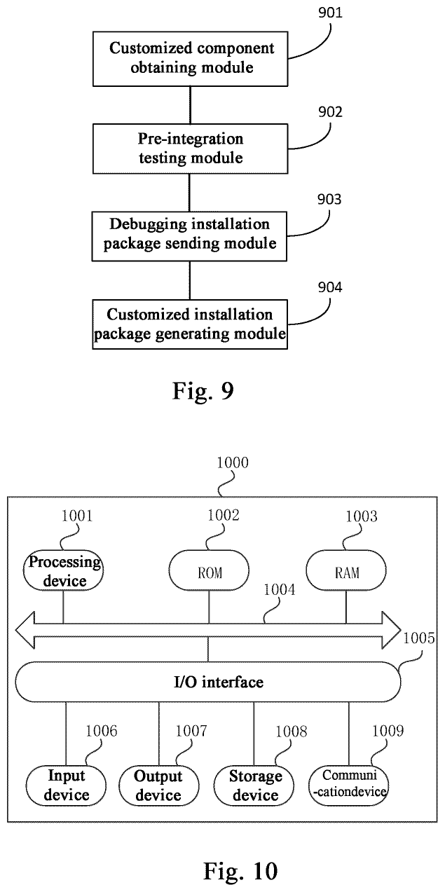

FIG. 9 illustrates a structural diagram of a component integration apparatus provided by the embodiments of the present disclosure. The apparatus is arranged at the service-side in the customized development system. The customized development system further includes a first client. As shown in FIG. 9, the apparatus includes:
a customized component obtaining module 901 for obtaining a first customized component corresponding to a first customized function submitted by the first client, wherein the first customized component is developed based on a development protocol provided by the service-side, the first customized function is used for meeting customization needs of a target user for a host application;
a pre-integration testing module 902 for performing a pre-integration test for the first customized component;
a debugging installation package sending module 903 for sending to the first client a first debugging installation package including the first customized component in case that a test result of the pre-integration test is PASS;
a customized installation package generating module 904 for generating a customized installation package including the first customized component and the host application after receiving a component release request corresponding to the first customized component sent by the first client.

Through the component integration apparatus provided by the embodiments of the present disclosure, the application developer may open the customization development capability to the enterprise customers with customization needs, such that the enterprise customer side can fulfill their customized needs. Accordingly, a process for developing the customized function of the enterprise customer side is decoupled from a process for developing the native application to reduce or even eliminate development work from the application developer targeted at the customization needs of the enterprise customers, thereby saving development costs, enhancing development efficiency and making the future maintenance less difficult. Subsequent to obtaining the customized component submitted by the client, the service-side in the customized development system first conducts the pre-integration test and then returns a debugging installation package to the client after the component passes the test. After receiving the component release request from the client, a customized installation package including the customized component is generated, to ensure normal integration of the customized function. As a result, the generated installation package can precisely meet the customization needs of the enterprise customer.

Optionally, the first debugging installation package is obtained through performing joint compiling and building on the first customized component and the host application.

Optionally, the apparatus also includes:
a demo project providing module for, prior to obtaining a first customized component corresponding to a first customized function submitted by the first client, providing to the first client a demo project corresponding to the host application, wherein the demo project includes the development protocol.

Optionally, the pre-integration testing module includes:
a content test unit for performing a content test on the first customized component;
a compilation test unit for, performing joint compiling and building on the first customized component and the host application after the content test is passed; if compilation is passed, obtaining an initial debugging installation package;
an owned service logic test unit for performing an owned service logic test of the host application for the initial debugging installation package, wherein the first debugging installation package includes an initial debugging installation package after the owned service logic test is passed.

Optionally, the content test unit is used for performing at least one of:
determining whether there is a call symbol for calling a preset interface in the first customized component;
determining whether a dependency relationship graph corresponding to the first customized component conflicts with dependency relationship corresponding to the host application, wherein a dependency relationship graph corresponding to the first customized component is submitted by the first client to the service-side;
determining whether there are conflicting method symbols and/or variables between the first customized component and the host application.

Optionally, the customized installation package generating module includes:
a hosting unit for hosting the first customized component after receiving a component release request corresponding to the first customized component sent by the first client;
an integration test unit for performing an integration test on a hosted customized component of the target user in response to generating instructions for a customized installation package of the target user;
an installation package generating unit for generating a customized installation package including the hosted customized component and the host application in case that a test result of the integration test is PASS.

Optionally, the customized development system further includes a second client; the hosted customized component includes a second customized component, the second customized component includes a customized component corresponding to a second customized function desired by the target user as submitted by the second client to the service-side; the first customized function and the second customized function are the same customized function or different customized functions.

Optionally, the integration test unit includes:
a compilation test sub-unit for performing joint compiling and building on a hosted customized component of the target user and the host application; if compilation is passed, obtaining an initial customized installation package;
an owned service logic test sub-unit for performing an owned service logic test of the host application for the initial installation package, wherein the customized installation package includes an initial customized installation package after the owned service logic test is passed.

Optionally, the apparatus also comprises:
a notification sending module for sending a re-release notification to the first client upon detecting that a version of the host application is upgraded to a target application version;
a re-release request receiving module for receiving a component re-release request of the first customized component sent by the first client, wherein the component re-release request includes a target development protocol version corresponding to the first customized component;
an installation package generating module for generating a customized installation package including the first customized component and a host application of the target application version upon determining that the target application version is compatible with the target development protocol version.

Optionally, the apparatus further comprises: a re-integration notification module for, upon determining that the target application version is incompatible with the target development protocol version, sending to the first client a re-integration notification, wherein the re-integration notification is used for prompting re-developing of the first customized component adopting a new development protocol compatible with the target application version.

The component integration apparatus provided by the embodiments of the present disclosure may execute the component integration method provided by any embodiments, includes the corresponding functional modules for executing the method and achieves the advantageous effects.

It is to be noteworthy that the respective units and modules included in the above apparatus are divided only by functional logic. The units and modules may also be divided in other ways as long as they can fulfill the corresponding functions. Further, the names of the respective functional units are provided only to distinguish one from another, rather than restricting the protection scope of the embodiments of the present disclosure.

FIG. 10 illustrates a structural diagram of an electronic device provided by the embodiments of the present disclosure. With reference to FIG. 10, a structural diagram of an electronic device (e.g., terminal device or server in FIG. 10) 1000 adapted to implement embodiments of the present disclosure is shown. In the embodiments of the present disclosure, the terminal device may include, but not limited to, mobile terminals, such as mobile phones, notebooks, digital broadcast receivers, PDAs (Personal Digital Assistant), PADs (tablet computer), PMPs (Portable Multimedia Player) and vehicle terminals (such as car navigation terminal) and fixed terminals, e.g., digital TVs and desktop computers etc. The electronic device shown in FIG. 10 is just an example and will not put any restrictions on the functions and application ranges of the embodiments of the present disclosure.

According to FIG. 10, the electronic device 1000 may include a processing device (e.g., central processor, graphic processor and the like) 1001, which can execute various suitable actions and processing based on the programs stored in the read-only memory (ROM) 1002 or programs loaded in the random-access memory (RAM) 1003 from a storage device 1008. The RAM 1003 can also store all kinds of programs and data required by the operations of the electronic device 1000. Processing device 1001, ROM 1002 and RAM 1003 are connected to each other via a bus 1004. The input/output (I/O) interface 1005 is also connected to the bus 1004.

Usually, input device 1006 (including touch screen, touchpad, keyboard, mouse, camera, microphone, accelerometer, gyroscope and like) and output device 1007 (including liquid crystal display (LCD), speaker and vibrator etc.), storage device 1008 (including tape and hard disk etc.) and communication device 1009 may be connected to the I/O interface 1005. The communication device 1009 may allow the electronic device 1000 to exchange data with other devices through wired or wireless communications. Although FIG. 10 illustrates the electronic device 1000 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including computer programs carried on a non-transient computer readable medium, wherein the computer programs include program codes for executing the method demonstrated by the flowchart. In these embodiments, the computer programs may be loaded and installed from networks via the communication device 1009, or installed from the storage device 1008, or installed from the ROM 1002. The computer programs, when executed by the processor 1001, performs the above functions defined in the method for video editing according to the embodiments of the present disclosure.

Names of the messages or information exchanged between a plurality of apparatuses in the implementations of the present disclosure are provided only for explanatory purpose, rather than restricting the scope of the messages or information.

The electronic device provided by the embodiments of the present disclosure and the component integration method according to the above embodiments belong to the same inventive concept. The technical details not elaborated in these embodiments may refer to the above embodiments. Besides, these embodiments and the above embodiments achieve the same advantageous effects.

Embodiments of the present disclosure provide a computer storage medium on which computer programs are stored, which programs when executed by a processor implement the component integration method provided by the above embodiments.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

In some implementations, clients and servers may communicate with each other via any currently known or to be developed network protocols, such as HTTP (HyperText Transfer Protocol) and interconnect with digital data communications in any forms or media (such as communication networks). Examples of the communication networks include Local Area Network (LAN), Wide Area Network (WAN), internet work (e.g., Internet) and end-to-end network (such as ad hoc end-to-end network), and any currently known or to be developed networks.

The above computer readable medium may be included in the aforementioned electronic device or stand-alone without fitting into the electronic device.

The above computer readable medium bears one or more programs. When the above one or more programs are executed by the electronic device, the electronic device is enabled to: obtain a first customized component corresponding to a first customized function submitted by the first client, wherein the first customized component is developed based on a development protocol provided by the service-side, the first customized function is used for meeting customization needs of a target user for a host application; perform a pre-integration test for the first customized component; in case that a test result of the pre-integration test is PASS, send to the first client a first debugging installation package including the first customized component and the host application; after receiving a component release request corresponding to the first customized component sent by the first client, generate a customized installation package including the first customized component and the host application.

Computer program instructions for executing operations of the present disclosure may be written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the module should not be considered as the restriction over the module per se. For example, the pre-integration testing module also may be described as “a module that performs a pre-integration test for the first customized component”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In accordance with one or more embodiments of the present disclosure, there is provided a component integration method applied at a service-side of a customized development system, the customized development system further includes a first client, wherein the method comprises:
obtaining a first customized component corresponding to a first customized function submitted by the first client, wherein the first customized component is developed based on a development protocol provided by the service-side, the first customized function is used for meeting customization needs of a target user for a host application;
performing a pre-integration test for the first customized component;
in case that a test result of the pre-integration test is PASS, sending to the first client a first debugging installation package including the first customized component and the host application;
after receiving a component release request corresponding to the first customized component sent by the first client, generating a customized installation package including the first customized component and the host application.

In accordance with one or more embodiments of the present disclosure, the first debugging installation package is obtained through performing joint compiling and building on the first customized component and the host application.

In accordance with one or more embodiments of the present disclosure, the method, prior to obtaining a first customized component corresponding to a first customized function submitted by the first client, further comprises:
providing to the first client a demo project corresponding to the host application, wherein the demo project includes the development protocol.

In accordance with one or more embodiments of the present disclosure, the performing a pre-integration test for the first customized component includes:
performing a content test on the first customized component;
after the content test is passed, performing joint compiling and building on the first customized component and the host application; if compilation is passed, obtaining an initial debugging installation package;
performing an owned service logic test of the host application for the initial debugging installation package, wherein the first debugging installation package includes an initial debugging installation package after the owned service logic test is passed.

In accordance with one or more embodiments of the present disclosure, the performing a content test on the first customized component includes at least one of:
determining whether there is a call symbol for calling a preset interface in the first customized component;
determining whether a dependency relationship graph corresponding to the first customized component conflicts with dependency relationship corresponding to the host application, wherein a dependency relationship graph corresponding to the first customized component is submitted by the first client to the service-side;
determining whether there are conflicting method symbols and/or variables between the first customized component and the host application.

In accordance with one or more embodiments of the present disclosure, the generating a customized installation package including the first customized component and the host application after receiving a component release request corresponding to the first customized component sent by the first client includes:
hosting the first customized component after receiving a component release request corresponding to the first customized component sent by the first client;
in response to generating instructions for a customized installation package of the target user, performing an integration test on a hosted customized component of the target user;
in case that a test result of the integration test is PASS, generating a customized installation package including the hosted customized component and the host application.

In accordance with one or more embodiments of the present disclosure, the customized development system further includes a second client; the hosted customized component includes a second customized component, the second customized component includes a customized component corresponding to a second customized function desired by the target user as submitted by the second client to the service-side; the first customized function and the second customized function are the same customized function or different customized functions.

In accordance with one or more embodiments of the present disclosure, the performing an integration test on a hosted customized component of the target user includes:
performing joint compiling and building on a hosted customized component of the target user and the host application; if compilation is passed, obtaining an initial customized installation package;
performing an owned service logic test of the host application for the initial installation package, wherein the customized installation package includes an initial customized installation package after the owned service logic test is passed.

In accordance with one or more embodiments of the present disclosure, the method further comprises:
upon detecting that a version of the host application is upgraded to a target application version, sending a re-release notification to the first client;
receiving a component re-release request of the first customized component sent by the first client, wherein the component re-release request includes a target development protocol version corresponding to the first customized component;
upon determining that the target application version is compatible with the target development protocol version, generating a customized installation package including the first customized component and a host application of the target application version.

In accordance with one or more embodiments of the present disclosure, the method further comprises:
upon determining that the target application version is incompatible with the target development protocol version, sending to the first client a re-integration notification, wherein the re-integration notification is used for prompting re-developing of the first customized component adopting a new development protocol compatible with the target application version.

In accordance with one or more embodiments of the present disclosure, there is provided a component integration apparatus configured at a service-side in a customized development system, the customized development system further includes a first client, wherein the apparatus comprises:
a customized component obtaining module for obtaining a first customized component corresponding to a first customized function submitted by the first client, wherein the first customized component is developed based on a development protocol provided by the service-side, the first customized function is used for meeting customization needs of a target user for a host application;
a pre-integration testing module for performing a pre-integration test for the first customized component;
a debugging installation package sending module for sending to the first client a first debugging installation package including the first customized component in case that a test result of the pre-integration test is PASS;
a customized installation package generating module for generating a customized installation package including the first customized component and the host application after receiving a component release request corresponding to the first customized component sent by the first client.

In accordance with one or more embodiments of the present disclosure, there is provided an electronic device, the electronic device comprising:
one or more processors;
a storage for storing one or more programs;
when the one or more programs are executed by the one or more processors, the one or more processors are caused to implement the component integration method.

In accordance with one or more embodiments of the present disclosure, there is provided storage medium containing computer executable instructions which, when executed by a computer processor, perform the component integration method according to embodiments of the present disclosure.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. A component integration method being applied at a service-side of a customized development system, the customized development system further includes a first client, the method comprises:
obtaining a first customized component corresponding to a first customized function submitted by the first client, wherein the first customized component is developed based on a development protocol provided by the service-side, the first customized function is used for meeting customization needs of a target user for a host application;
performing a pre-integration test for the first customized component;
in case that a test result of the pre-integration test is PASS, sending to the first client a first debugging installation package including the first customized component and the host application;
after receiving a component release request corresponding to the first customized component sent by the first client, generating a customized installation package including the first customized component and the host application.

2. The method of claim 1, wherein the first debugging installation package is obtained thorough performing joint compiling and building on the first customized component and the host application.

3. The method of claim 1, wherein the method, prior to obtaining a first customized component corresponding to a first customized function submitted by the first client, further comprises:
providing to the first client a demo project corresponding to the host application, wherein the demo project includes the development protocol.

4. The method of claim 1, wherein performing a pre-integration test for the first customized component includes:
performing a content test on the first customized component;
after the content test is passed, performing joint compiling and building on the first customized component and the host application; if compilation is passed, obtaining an initial debugging installation package;
performing an owned service logic test of the host application for the initial debugging installation package, wherein the first debugging installation package includes an initial debugging installation package after the owned service logic test is passed.

5. The method of claim 4, wherein performing a content test on the first customized component includes at least one of:
determining whether there is a call symbol for calling a preset interface in the first customized component;
determining whether a dependency relationship graph corresponding to the first customized component conflicts with dependency relationship corresponding to the host application, wherein a dependency relationship graph corresponding to the first customized component is submitted by the first client to the service-side;
determining whether there are conflicting method symbols and/or variables between the first customized component and the host application.

6. The method of claim 1, wherein generating a customized installation package including the first customized component and the host application after receiving a component release request corresponding to the first customized component sent by the first client includes:
hosting the first customized component after receiving a component release request corresponding to the first customized component sent by the first client;
in response to generating instructions for a customized installation package of the target user, performing an integration test on a hosted customized component of the target user;
in case that a test result of the integration test is PASS, generating a customized installation package including the hosted customized component and the host application.

7. The method of claim 6, wherein the customized development system further includes a second client; the hosted customized component includes a second customized component, the second customized component includes a customized component corresponding to a second customized function desired by the target user as submitted by the second client to the service-side; the first customized function and the second customized function are the same customized function or different customized functions.

8. The method of claim 6, wherein performing an integration test on a hosted customized component of the target user includes:
performing joint compiling and building on a hosted customized component of the target user and the host application; if compilation is passed, obtaining an initial customized installation package;
performing an owned service logic test of the host application for the initial installation package, wherein the customized installation package includes an initial customized installation package after the owned service logic test is passed.

9. The method of claim 1, further comprising:
upon detecting that a version of the host application is upgraded to a target application version, sending a re-release notification to the first client;
receiving a component re-release request of the first customized component sent by the first client, wherein the component re-release request includes a target development protocol version corresponding to the first customized component;
upon determining that the target application version is compatible with the target development protocol version, generating a customized installation package including the first customized component and a host application of the target application version.

10. The method of claim 9, further comprising:
upon determining that the target application version is incompatible with the target development protocol version, sending to the first client a re-integration notification, wherein the re-integration notification is used for prompting re-developing of the first customized component adopting a new development protocol compatible with the target application version.

11. An electronic device comprising:
one or more processors;
a storage for storing one or more programs;
when the one or more programs are executed by the one or more processors, the one or more processors are caused to implement a component integration method being applied at a service-side of a customized development system, the customized development system further includes a first client, the method comprises:
obtaining a first customized component corresponding to a first customized function submitted by the first client, wherein the first customized component is developed based on a development protocol provided by the service-side, the first customized function is used for meeting customization needs of a target user for a host application;
performing a pre-integration test for the first customized component;
in case that a test result of the pre-integration test is PASS, sending to the first client a first debugging installation package including the first customized component and the host application;
after receiving a component release request corresponding to the first customized component sent by the first client, generating a customized installation package including the first customized component and the host application.

12. The electronic device of claim 11, wherein the first debugging installation package is obtained thorough performing joint compiling and building on the first customized component and the host application.

13. The electronic device of claim 11, wherein the method, prior to obtaining a first customized component corresponding to a first customized function submitted by the first client, further comprises:
providing to the first client a demo project corresponding to the host application, wherein the demo project includes the development protocol.

14. The electronic device of claim 11, wherein performing a pre-integration test for the first customized component includes:
performing a content test on the first customized component;
after the content test is passed, performing joint compiling and building on the first customized component and the host application; if compilation is passed, obtaining an initial debugging installation package;
performing an owned service logic test of the host application for the initial debugging installation package, wherein the first debugging installation package includes an initial debugging installation package after the owned service logic test is passed.

15. The electronic device of claim 14, wherein performing a content test on the first customized component includes at least one of:
determining whether there is a call symbol for calling a preset interface in the first customized component;
determining whether a dependency relationship graph corresponding to the first customized component conflicts with dependency relationship corresponding to the host application, wherein a dependency relationship graph corresponding to the first customized component is submitted by the first client to the service-side;
determining whether there are conflicting method symbols and/or variables between the first customized component and the host application.

16. The electronic device of claim 11, wherein generating a customized installation package including the first customized component and the host application after receiving a component release request corresponding to the first customized component sent by the first client includes:
hosting the first customized component after receiving a component release request corresponding to the first customized component sent by the first client;
in response to generating instructions for a customized installation package of the target user, performing an integration test on a hosted customized component of the target user;
in case that a test result of the integration test is PASS, generating a customized installation package including the hosted customized component and the host application.

17. The electronic device of claim 16, wherein the customized development system further includes a second client; the hosted customized component includes a second customized component, the second customized component includes a customized component corresponding to a second customized function desired by the target user as submitted by the second client to the service-side; the first customized function and the second customized function are the same customized function or different customized functions.

18. The electronic device of claim 16, wherein performing an integration test on a hosted customized component of the target user includes:
performing joint compiling and building on a hosted customized component of the target user and the host application; if compilation is passed, obtaining an initial customized installation package;
performing an owned service logic test of the host application for the initial installation package, wherein the customized installation package includes an initial customized installation package after the owned service logic test is passed.

19. The electronic device of claim 11, further comprising:
upon detecting that a version of the host application is upgraded to a target application version, sending a re-release notification to the first client;
receiving a component re-release request of the first customized component sent by the first client, wherein the component re-release request includes a target development protocol version corresponding to the first customized component;
upon determining that the target application version is compatible with the target development protocol version, generating a customized installation package including the first customized component and a host application of the target application version.

20. A non-transitory storage medium containing computer executable instructions which, when executed by a computer processor, perform a component integration method being applied at a service-side of a customized development system, the customized development system further includes a first client, the method comprises:
obtaining a first customized component corresponding to a first customized function submitted by the first client, wherein the first customized component is developed based on a development protocol provided by the service-side, the first customized function is used for meeting customization needs of a target user for a host application;
performing a pre-integration test for the first customized component;
in case that a test result of the pre-integration test is PASS, sending to the first client a first debugging installation package including the first customized component and the host application;
after receiving a component release request corresponding to the first customized component sent by the first client, generating a customized installation package including the first customized component and the host application.
